(19) United States
(12) Patent Application Publication
(10) Pub. No.: US 2025/0103322 A1
(43) Pub. Date: Mar. 27, 2025

(54) Bootloader for Device Firmware Upgrade

(71) Applicant: QUALCOMM Incorporated, San Diego, CA (US)

(72) Inventors: Himanshu SRIVASTAVA, Bangalore (IN); Suhaskumar PATEL, Bangalore (IN)

(21) Appl. No.: 18/471,347

(22) Filed: Sep. 21, 2023

(51) Int. Cl. G06F 8/654

(52) U.S. Cl. CPC G06F 8/654

(57) ABSTRACT

Various embodiments include systems and methods for updating firmware on a computing device. A computing device may determine essential image sections and non-essential image sections of a working firmware image stored in a flash memory of the computing device. The computing device may store the data in the non-essential image sections on a host device as a backup image, erase the data in the non-essential image sections from the flash memory, receive an update firmware image from the host device, store essential image sections of the update firmware image to the flash memory, and reboot the computing device from the essential image sections of the update firmware image stored in the flash memory.

### BACKGROUND

Firmware is specialized software that resides within a hardware device and acts as a bridge between the hardware components and the operating system or other higher-level software. In modern computing systems, firmware may be used to provide hardware control, system initialization, hardware configuration, system diagnostics, etc. Firmware may ensure that the entire system operates cohesively and efficiently by providing precise control and management of the hardware. As technology continues to evolve, the complexity and responsibilities of firmware are likely to increase, making it an important component in the functionality and reliability of contemporary computing devices.

Firmware often requires updates to improve functionality, fix bugs, or enhance security. There are generally manual and automated procedures for performing firmware updates. Manual procedures may involve user intervention at various stages, while automated processes could be conducted without user intervention through scheduled tasks or specific triggers defined by the system or user preferences.

Device Firmware Upgrade (DFU) is a procedure that facilitates the modification or updating of the firmware embedded within a hardware device. A manual DFU process may be initiated by the user or a technician using special software tools provided by the device's manufacturer. Automated DFU processes may be initiated or triggered by system-defined parameters, scheduled tasks, or conditions such as the availability of a new firmware version from the manufacturer.

Traditional DFU processes typically include using a specific mode in the computing device that enables the firmware to be erased and rewritten. Improper execution of DFU process may compromise the device's integrity and/or result in a loss of functionality. As such, DFU processes often include fail-safes, such as retaining a backup of the original firmware to allow rollback if the upgrade fails. These fail-safes may be important for preventing the device from entering a non-functional or ‘bricked’ state.

### SUMMARY

Various aspects include methods and processing systems performing the methods for performing device firmware updates in applications in which the amount of available memory for storing a firmware update image is limited. Various aspects include methods of updating firmware on a computing device, which may include receiving an update firmware image from a host device, determining essential image sections and non-essential image sections of a working firmware image stored in a flash memory of the computing device, erasing data in the non-essential image sections from the flash memory, storing essential image sections of the update firmware image to the flash memory, and rebooting the computing device from the essential image sections of the update firmware image stored in the flash memory. Some aspects may further include storing the data in the non-essential image sections on the host device as a backup image prior to erasing the data in the non-essential image sections from the flash memory.

Some aspects may further include sending a request to establish a connection to the host device in response to rebooting the computing device from the essential image sections of the update firmware image stored in the flash memory. Some aspects may further include rebooting from the essential image sections of the working firmware image in response to a failure to establish a connection to the host device. Some aspects may further include requesting and receiving the data in the non-essential image sections from the host device after rebooting from the essential image sections of the working firmware image, and storing the received data in flash memory of the computing device. Some aspects may further include in response to successfully reconnecting to the host device committing the essential image sections of the update firmware image to the flash memory, erasing the essential image sections of the working firmware image, and storing non-essential image sections of the update firmware image received from the host device in the flash memory. In some aspects, receiving the update firmware image from the host device may include receiving the update firmware image from a remote application operating on a server computing device that is connected to the computing device over wire or wireless communication channels. In some aspects, receiving the update firmware image from the host device may include receiving the update firmware image from the host device comprises receiving the update firmware image from a memory controller component of the computing device.

Further aspects may include a computing device having a processing system configured with processor-executable instructions to perform various operations corresponding to the methods summarized above. Further aspects may include a non-transitory processor-readable storage medium having stored thereon processor-executable instructions configured to cause a processing system to perform various operations corresponding to the method operations summarized above. Further aspects may include a computing device having various means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating example components in system in package (SIP) that may be included in a computing device and configured to implement some embodiments.

FIG. 2 is a component block diagram illustrating example operations and data stored in flash memory of a computing device configured to implement some embodiments.

FIG. 3 is a process flow diagram illustrating a method of updating firmware in a computing system in accordance with some embodiments.

FIG. 4 is a component block diagram illustrating an example computing device in the form of a laptop that is suitable for implementing some embodiments.

FIG. 5 is a component block diagram illustrating an example wireless communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and processing system that enable device firmware updates in applications in which the amount of available memory for storing a firmware update image is limited. Various embodiments may include updating firmware moving non-essential image sections of a working firmware image stored in a flash memory of the computing device to a host device as a backup image, storing an update firmware image from the host device in the portion of the flash memory previously storing a non-essential image sections and rebooting the computing device from the essential image sections of the update firmware image stored in the flash memory. After rebooting, the computing device may attempt to establish a connection to the host device. If a connection to the host device is not reestablished, the computing device may reboot from the essential image sections of the working firmware image, request and receive the data in the non-essential image sections from the host device, and store the received data in flash memory of the computing device. If a connection to the host device is established, the computing device may commit the essential image sections of the update firmware image to the flash memory, erase the essential image sections of the working firmware image, and store non-essential image sections of the update firmware image received from the host device in the flash memory.

The term “computing device” may be used herein to refer to any one or all of personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., earbuds, smartwatch, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processing system that can be configured to provide the functionality of various embodiments.

The term “processing system” is used herein to refer to one more processors, including multi-core processors, that are organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) may be used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “firmware” is used herein to refer to a specific class of computer software that provides the low-level control for a computing device's hardware. Unlike typical software applications that may be easily modified or removed by the end-user, firmware often resides in the non-volatile memory of the device, such as ROM, PROM, or flash memory, allowing it to retain its state even when the device is powered off. Firmware may be an intermediary layer between the device's hardware and operating system, handling tasks such as initialization of hardware components, execution of essential system services, monitoring, and control of physical devices, and implementation of protocols for communication with other systems. Examples of firmware include the basic input/output system (BIOS) in a personal computer that facilitates the boot process, router firmware that manages network communication protocols, embedded firmware in an automobile that controls electronic components such as airbags and fuel injection systems, and the firmware in a digital camera that oversees image processing functions. Firmware updates introducing enhancements, security improvements, or bug fixes may be deployed to a computing device through a device firmware upgrade (DFU) process.

The term “firmware image” is used herein to refer to a compiled and assembled file that includes the code and data for a hardware device's operation. A firmware image may be the permanent software programmed into a device's read-only memory (ROM) or flash memory. The “image” may be a snapshot of the firmware system at a specific point in time, encompassing all components needed to boot and run the device. Examples of the types of information that may be included in a firmware image include the operating system kernel, device drivers, configuration settings, initialization routines, and application code specific to the device. A firmware image may also include security protocols and authentication data to ensure the system's integrity. In embedded systems, the firmware image may serve to operate as an interface between the device's hardware and software, managing low-level functions and providing a consistent environment in which the system operates. A firmware image may be tailored to the particular hardware so as to ensure optimal performance and functionality.

The term “device firmware upgrade (DFU)” is used herein to refer to a specialized procedure or method used to update or modify the firmware residing within a computing device's flash memory. The firmware, serving as a foundational layer of software, orchestrates the interaction between the device's hardware and the higher-level software layers. The DFU process may be initiated to introduce new features, enhance existing functionalities, rectify identified issues, improve security protocols, or optimize performance. DFU operations may be facilitated through a host computing device configured to transfer the required firmware image to the target device over wire or wireless connections. Examples of scenarios initiating a DFU include releasing a new operating system version, patching a known security vulnerability, calibrating, or tuning hardware components, or refreshing device configurations to accommodate evolving standards or regulations. DFU procedures may include provisions for validation, verification, and potential rollback to ensure the integrity, authenticity, and reliability of the updated firmware.

As used in this application, the term “host device” is intended to include a computer-related entity or component that is configured to facilitate network and/or memory access. A host device may be integrated into the client computing system or may be a separate and independent computing device/system. As examples, the host device may be a memory controller component included in the client computing system, a component in the client computing system coupled to a memory controller, a SOC in the client computing system, a mobile device connected to a client computing device, or an independent server computing device that includes independent memory and is coupled to the client computing system via wired or wireless communication links. Thus, in various embodiments, the host device's memory may be included as part of the computing system's overall memory architecture or may include its own separate and independent memory resources. In some embodiments, the memory of the host device may serve as the repository for non-essential image sections. In some embodiments, the host device may be, may control, or may interact with a memory controller in the computing system and/or otherwise support various memory storage configurations. In some embodiments, the host device may be implemented in hardware, firmware, software or any combination thereof. In virtualization environments, a single physical host device may include one or more virtual machines that each function as an independent host device within the overarching hardware framework. The host device may be configured to operate in conjunction with various processes and/or threads of execution, may be confined to a single processor or may be dispersed among several processors, and/or may be configured to communicate with the memory and/or the client computing system through local and remote processes, function calls, electronic signals, data packets, etc.

In some embodiments, a host may be a remote application operating on a server computing device that is connected to a client computing device (e.g., earbuds, headset, etc.) over wire or wireless communication channels. In some embodiments, a host may be responsible for the transfer of a firmware image (e.g., DFU image) and the oversight of the firmware update operations. The host may be configured to facilitate the exchange of information between the computing device and the system performing the updates, operate as a centralized manager, and/or control, enforce, ensure, and/or verify the implementation of the firmware upgrade protocols. Examples of hosts may include server applications designed specifically for DFU processes, computer systems equipped with proprietary software for device management, cloud-based platforms that deliver firmware updates to a fleet of connected devices, or mobile applications on smartphones that interface with wearable or IoT devices for regular updates. A host may also incorporate various security and validation measures to confirm the authenticity of the firmware image and/or to preserve the integrity and reliability of the update process. It may be tailored to interact seamlessly with different types of computing devices and firmware images, thus serving as a bridge that links various hardware, firmware, software, and communication components.

The term “essential image” is used herein to refer to a specific category of firmware images that are required for connecting with a host and executing a device firmware update (DFU). Essential images may include the fundamental code and data necessary for establishing and maintaining communication with the host. Essential images may also include new firmware components that are intended to be merged with their existing counterparts (such as read-write sections) to become useable or functional in the computing device. An essential image may include specific protocols for secure communication, initialization routines for hardware configuration, and logic to facilitate the merging of new and existing firmware sections.

The term “non-essential image” is used herein to refer to a subset of firmware images that, unlike essential images, are not required for performing the DFU operations. Non-essential images may include additional features, supplementary applications, user interface components, or other non-critical elements that do not directly contribute to the core functionality required to connect with the host and conduct the DFU process. Examples of non-essential images may include localized language packs, supplementary media codecs, extra graphical elements, or specialized device drivers that enhance but do not impose, dictate, or control the firmware upgrade operation of the device. While non-essential images may enhance the usability, efficiency, or user experience of the computing device, their absence or failure does not impede the DFU operations. Non-essential images may be included in an update package but not prioritized in the DFU process. A computing device may apply different rules and procedures to non-essential images than essential images.

The term “DFU Only Mode” is used herein to refer to a specialized operational state of a computing device in which the computing device may initiate and perform DFU operations without using non-essential images. The DFU Only Mode may isolate the core functions necessary for the successful execution of a firmware update, prioritizing only the essential images that are required to connect with the host and perform the DFU. The DFU Only Mode may be invoked in scenarios in which the focus is solely on the firmware update, and other supplementary or non-critical functionalities of the device are not needed. Examples of situations suitable for using the DFU Only Mode include emergency firmware recovery, critical security patches, or streamlined updates for a fleet of devices in which non-essential features are temporarily disregarded. A computing device operating in the DFU Only Mode may follow a specific boot sequence that bypasses regular initialization routines or user interfaces. A computing device operating in the DFU Only Mode may focus on the most important components of the update.

The term “rollback” is used herein to refer to a specific firmware update process or operation in which the computing device abandons or reverts from a newly installed or updated firmware image to a previous (stable) version of the firmware image. Rollback operations may be performed in response to detecting various issues in the update or upgrade procedure, such as incompatibilities, errors, or other unforeseen complications that might adversely affect the operation or stability of the device. The rollback operations typically rely on the presence of backup or preserved copies of the earlier software image, enabling the device to restore itself to a previous state that was functional and dependable. Rollback operations may be implemented as part of an overall DFU strategy.

Conventional DFU solutions (e.g., Bank A/B schemes, etc.) are not well suited for use in chipsets that have smaller flash memories. These solutions may necessitate considerable extra flash space to maintain the original image, which may increase the flash size requirements and inflate overall manufacturing costs. For example, a computing device implementing a Bank A/B scheme may initiate the process by flashing a boot image and dividing the remaining flash into two equal parts (e.g., Bank A and Bank B). Bank A may initially include the boot image and subsequently serve as the running image on the computing device. Bank B may be empty to receive DFU data from a host device. The computing device may copy a portion of the new image to Bank B, transfer the remainder from the existing boot bank to form a complete working image in Bank B, perform a hash check to verify the authenticity of the source, reboot from Bank B, perform sanity checks (e.g., reconnection, etc.), commit the image in Bank B to establish Bank B as the new boot bank, alter one or more bits to direct future reboots to Bank B, and erase Bank A in preparation for subsequent DFU processes.

To ensure there is sufficient free space for the DFU operation to proceed, the above-described Bank A/B scheme may require that the running image be half the size of the total flash. For example, if the flash size is 128 megabits, the running image may not exceed 64 megabits. Such size constraints render the scheme unsuitable for newer chipsets offering complex functionality with more modest flash memory sizes. Implementing these schemes in cost-sensitive chipsets might entail either sacrificing functionality or incurring additional expenses, both of which might not be satisfactory in numerous systems. Other traditional DFU systems may share similar constraints, resulting in substantial increases in flash size requirements and associated costs.

Traditional bootloader DFU solutions rely on a small part of the bootloader to boot the device. This “small footprint” model, in which only a small portion of the bootloader image is used and stored primarily in ROM, may leave the rest of the flash to be populated solely by the DFU process. Upon booting, the device may use this small footprint bootloader and wait for the host to send the remaining image, usually via a wired medium such as a Universal Serial Bus (USB). Once received, the device may boot from this image and attain functionality.

Implementing a traditional bootloader DFU solution may present a number of specific challenges or limitations. For example, the device may need to operate solely from the bootloader during the erasure and rewriting of the new image, relying on more basic or lightweight code. This restricted operation might impede the device's capability to execute DFU wirelessly, perform intricate validations, or manage the DFU process efficiently. Such limitations may become particularly troublesome if a newly deployed image is unsuccessful or faulty, potentially impacting the overall device performance.

Delta DFU schemes may only transmit the differences, or the “delta,” between the new and original images over the air. These solutions may require complex operations to compare the images and generate a Delta DFU image, which may be much smaller than the full image. The device may combine the Delta DFU with the original image to create and run the new image. The scheme might need reserved flash space to store the Delta DFU, constraining its size. If the delta exceeds the reserved space, the update may need distribution in multiple stages. These and other inherent complexities in Delta DFU solutions often require the use of standard utilities (e.g., BSD, etc.) to create and apply the delta. Such approaches may lack support for implicit patching and security and may prove unsuitable in cases where rollback to previous images is desirable, especially in specific applications such as music chipsets.

Various embodiments may include computing devices configured to implement a memory-efficient and cost-effective DFU scheme that uses less flash memory without compromising the functionality or integrity of the DFU process. As such, these embodiments may be particularly well suited for use in the next-generation chipsets and embedded devices, which often include smaller flash memory sizes.

In some embodiments, the computing devices may be configured to implement a DFU scheme that divides the memory into essential and non-essential images and uses sequential backup, discard, download, and validation procedures to provide a robust and streamlined firmware upgrade procedure suitable for use in emerging chipsets and embedded products. The computing devices may be configured to balance tradeoffs between the benefits of an efficient and reliable DFU process with the constraints of flash size and the requirements for rollback functionality. The computing devices may reduce the risk of bricking, leverage existing code, and/or conduct partial upgrades for essential image sections.

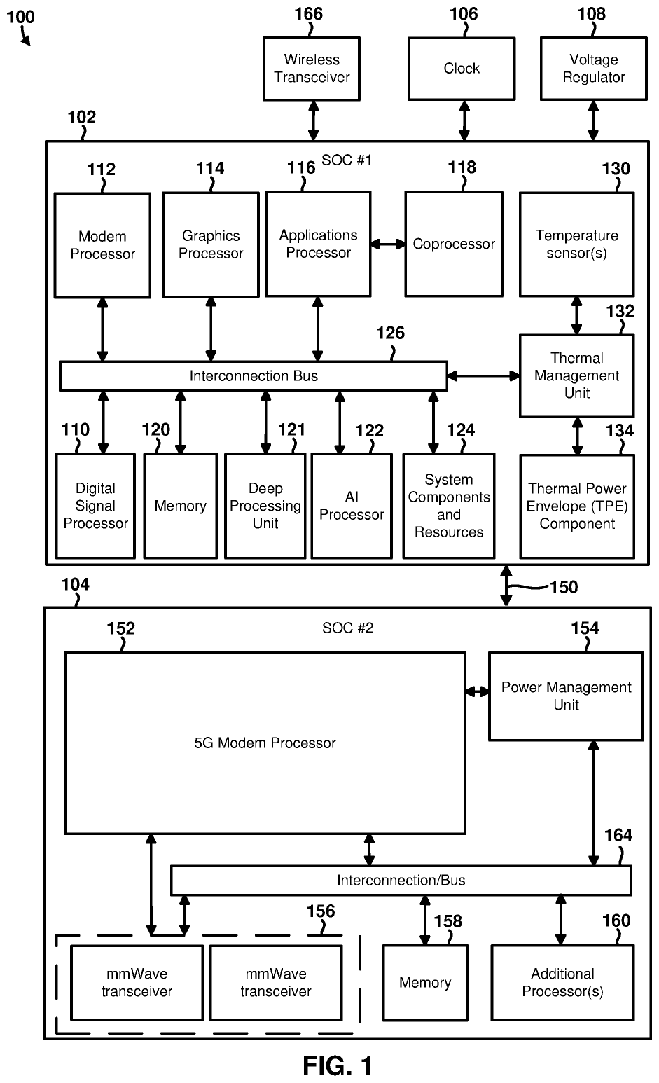

Various embodiments may be implemented on a number of single-processor and multiprocessor computer systems, including a system-on-chip (SOC) or system in a package (SIP). FIG. 1 illustrates an example computing system or SIP 100 architecture that may be used in mobile computing devices implementing various embodiments.

With reference to FIG. 1, the illustrated example SIP 100 includes two SOCs 102, 104, a clock 106, a voltage regulator 108, and a wireless transceiver 166. The first and second SOC 102, 104 may communicate via interconnection bus 150. The various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mm Wave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any or all of the processors 110, 112, 114, 116, 121, 122, in the system may operate as the SoC's main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mm Wave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, deep processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a mobile computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as a clock 106, a voltage regulator 108, and a wireless transceiver 166 (e.g., cellular wireless transceiver, Bluetooth transceiver, etc.). Resources external to the SOC (e.g., clock 106, voltage regulator 108, wireless transceiver 166) may be shared by two or more of the internal SOC processors/cores.

In addition to the example SIP 100 discussed above, various embodiments may be implemented in a wide variety of computing systems, including a single processor, multiple processors, multicore processors, or any combination thereof.

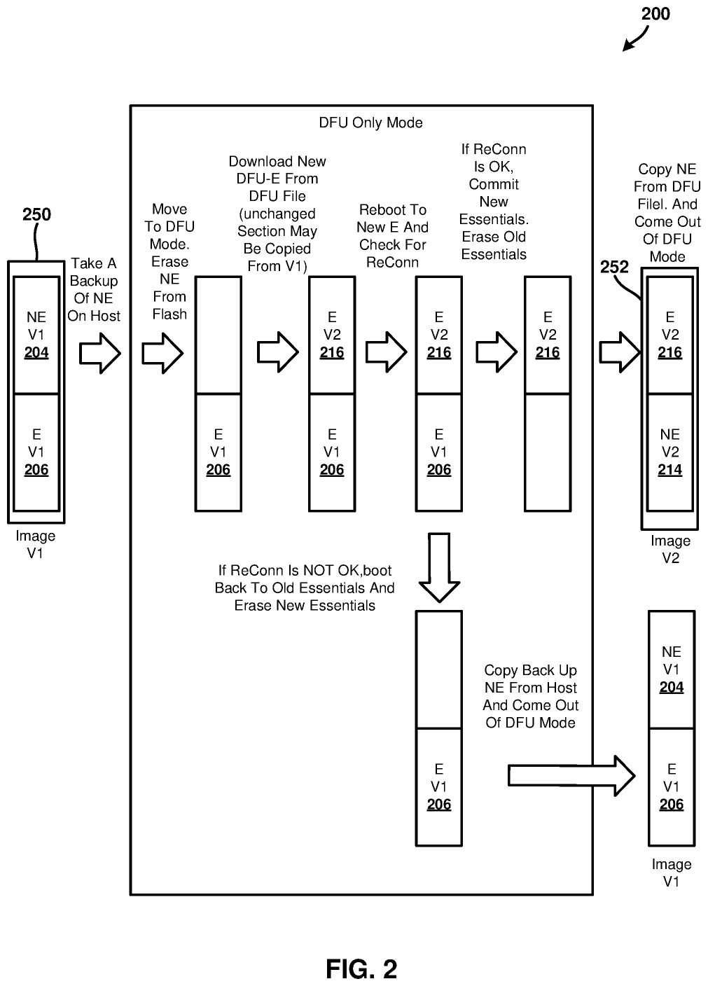

FIG. 2 illustrates example components that could be included in a system configured to perform DFU operations such that essential and non-essential images are handled separately in accordance with the embodiments. With reference to FIGS. 1 and 2, a system 200 (e.g., SIP 100, SOCs 102, 104, etc.) may partition a firmware image 250 (image V1) 250 into non-essential images 204 (NE-V1) and essential images 206 (E-V1), and verify that the system complies with various prerequisites for the DFU operations, which may include backup and rollback support prerequisites, DFU file structure prerequisites, essential image size prerequisites, and non-essential image handling prerequisites.

The system 200 may determine compliance of a firmware image 250 with backup and rollback support prerequisites by determining whether the client computing device includes support for rollback and/or support for storing a backup image on a host that may be retrieved by the device if issues arise during the DFU. Storing a backup image on the host is particularly important for rollback operations, which is a procedure that allows the device to revert to a previous stable version of the software image if the upgrade encounters problems. In some embodiments, the system may disregard the backup and rollback support prerequisites. In these embodiments, in response to detecting a failure in the DFU operations, the device may remain in DFU mode and wait for the next proper DFU operation to restore functionality.

The system 200 may determine its compliance with DFU file structure prerequisites by determining whether the essential image sections of the DFU file are positioned at the beginning of the DFU file, followed by the non-essential image sections. The essential image sections may include images that are required for the DFU process, such as Applications (Apps), Bluetooth (BT), and Persistent Storage (e.g., database, file system, etc.). In some embodiments, the DFU file may include additional image sections (if the total size remains within certain constraints).

The system 200 may determine its compliance with essential image size prerequisites by determining whether the size of the essential elements in the DFU process exceeds half of the available flash memory. That is, the processing system may verify that the essential images 206 are not larger than half of the flash memory size of the computing system 200. This prerequisite may help ensure that there is sufficient space to accommodate these fundamental parts without hindering the rest of the DFU operations. Operations that need to be merged with older counterparts (e.g., read-write operations) may be included in the essential image sections. Additional elements may also be marked as essential if the total size of the essential image 206 does not exceed half of the flash memory size.

The system 200 may determine its compliance with non-essential image handling prerequisites by determining whether all non-essential image sections that do not directly contribute to the core DFU operations are included in the DFU file (partial DFU support for non-essentials is not accommodated in this scheme).

The system 200 may backup the non-essential images (NE-V1) on the host as safety measure (for later restoration if needed).

The system 200 may enter DFU mode and erase non-essential images from the device's flash memory.

The system 200 may download new essential images 216 (E-V2) from the DFU file. In some embodiments, the system 200 may download or access essential images 206 (E-V1) and essential images 216 (E-V2), and directly copy the sections that are unchanged from the previous essential (E-V1).

The system 200 may reboot to the new essential images to check the connectivity (ReConn). In response to determining that the reconnection is successful, the system 200 may commit (save persistently) the new essential images, erase the old essential images 206, copy the non-essential images 214 from the DFU file to generate image V2 252.

In response to determining that the reconnection is not successful, the system 200 may boot back to the old essential images (E-V1), erase newly downloaded essential images (E-V2), restore non-essential images (NE-V1) from the host backup (i.e., image V1 250), and exit the DFU mode.

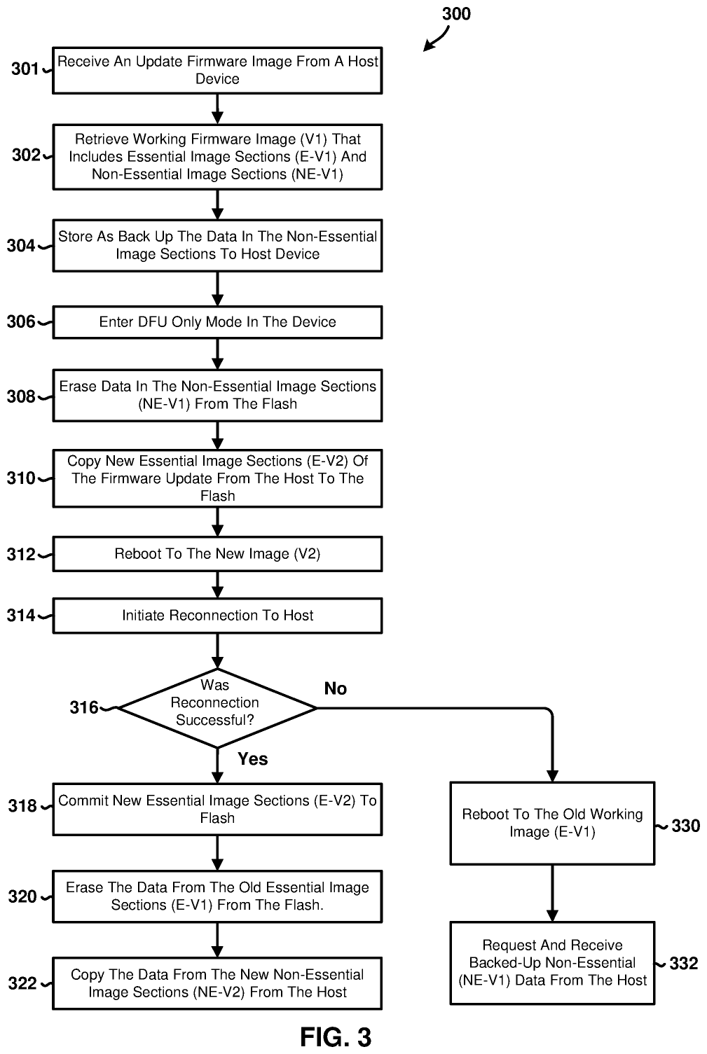

FIG. 3 is a process flow diagram illustrating a method 300 of performing DFU operations in accordance with some embodiments. With reference to FIGS. 1-3, the method 300 may be performed in a computing device by processing system encompassing one or more processors (e.g., 110, 112, 114, 116, 118, 121, 122, 121, 122, 152, 160, etc.), components or subsystems discussed in this application. Means for performing the functions of the operations in the method 300 may include a processing system including one or more of processors 110, 112, 114, 116, 118, 121, 122, 121, 122, 152, 160, and other components described herein. Further, one or more processors of a processing system may be configured with software or firmware to perform some or all of the operations of the method 300. In order to encompass the alternative configurations enabled in various embodiments, the hardware implementing the method 300 is referred to herein as a “processing system.”

In block 301, the processing system may receive an update firmware image from a host device. In some embodiments, the update firmware image may be received from a remote application operating on a server computing device that is connected to the computing device over wire or wireless communication channels. In some embodiments, the update firmware image may be received from a memory controller component of a connected computing device. In some embodiments, the flash memory device and processing system may be in a peripheral device (e.g., earbuds, a smart watch, augmented reality glasses or goggles, and the like) that is wired or wirelessly coupled to a computing device that provides the update firmware image and acts as the host device for completing an update of flash memory device.

In block 302, the processing system may retrieve the working firmware image (V1) that includes essential image sections (E-V1) and non-essential image sections (NE-V1). For example, when the device is powered on or rebooted, a boot loader may initialize the hardware, identify the location of the working firmware image (V1) in the device's flash memory, and load the essential and non-essential sections working firmware image (V1) into the device's RAM or another working memory space.

In block 304, the processing system may store as a backup of the data in the non-essential image sections to the host device as a safeguard. As discussed above, in some embodiments, the host device may be a memory controller component, a remote application operating on a server computing device that is connected to the processing system over wire or wireless communication channels, etc. By backing up the non-essential sections, the processing system may revert back to its original state if an update fails or other issues occur during the DFU operations.

In block 306, the processing system may enter DFU only mode in the device. The DFU only mode causes the device to into a state that supports the specific requirements of a firmware update and/or so that the update operations are performed without interference from other running processes or services.

In block 308, the processing system may erase data in the non-essential image sections (NE-V1) from the flash. By erasing the non-essential sections, the processing system may free up often limited flash memory space for the new firmware components.

In block 310, the processing system may copy new essential image sections (E-V2) of the firmware update from the host to the flash (e.g., in the space cleared by erasing non-essential sections). By simultaneously storing both the working essential sections (E-V1) and the new essential sections (E-V2) in the flash, the device may maintain its ability to function and stay connected even if the update or upgrade fails.

In some embodiments, the operations in block 308 of erasing data in the non-essential image sections (NE-V1) from the flash may be performed by the processing system storing the new essential image sections (E-V2) of the firmware update in the memory addresses storing the non-essential image sections (NE-V1), thus overwriting the non-essential image sections in block 310.

In block 312, the processing system may reboot to the new image (E-V2). The reboot may allow the device to start using the new essential image sections (E-V2) that were copied to the flash. For example, the reboot may activate the newly copied essential sections, and allow the device to verify the successful implementation, perform any remaining upgrade operations, assess reconnect capability, etc.

In block 314, the processing system may initiate a reconnection to the host to validate the integrity or functionality of the new essential image sections (E-V2).

In determination block 316, the processing system may determine whether the device successfully reconnected to the host. A successful reconnection may indicate that the new firmware is operating as expected and that the device has retained its ability to communicate with external entities such as the host.

In response to successfully reconnecting to the host or in response to determining that the reconnection to the host was successful (i.e., determination block 316=“Yes”), the processing system may commit new essential image sections (E-V2) to flash in block 318. By committing the E-V2 to flash, the processing system ensures that the new essential image sections become the permanent firmware version for the device.

In block 320, the processing system may erase the data from the old essential image sections (E-V1) from the flash. Erasing the old essential image sections (E-V1) may free up space in the often limited flash memory.

In block 322, the processing system may copy the data from the new non-essential image sections (NE-V2) from the host. That is, after successfully updating the essential image sections (E-V2) and freeing up space in the flash memory, the processing system may reintegrate the non-essential image sections to complete the firmware update process. The non-essential sections may include features, settings, or optional components that are part of the overall firmware but not mandatory for upgrade functionality.

In response to a failure to establish a connection to the host device or in response to determining that the reconnection to the host was not successful (i.e., determination block 316=“No”), the processing system may revert or rollback to the old working image (V1) in block 330. That is, the failure to reconnect to the host may indicate that there is an issue with the new image (V2). As such, the processing system may revert to using the old working image to ensure that the device continues to function as expected with a known, stable version of the firmware.

In block 332, the processing system may request and receive the backed-up non-essential (NE-V1) data from the host. As discussed above, the non-essential data may include configurations, settings, additional functionalities, etc. that, while not required for the upgrade operation of the device, may contribute to its full feature set. By retrieving this data from the host in block 332, the processing system may restore these additional features.

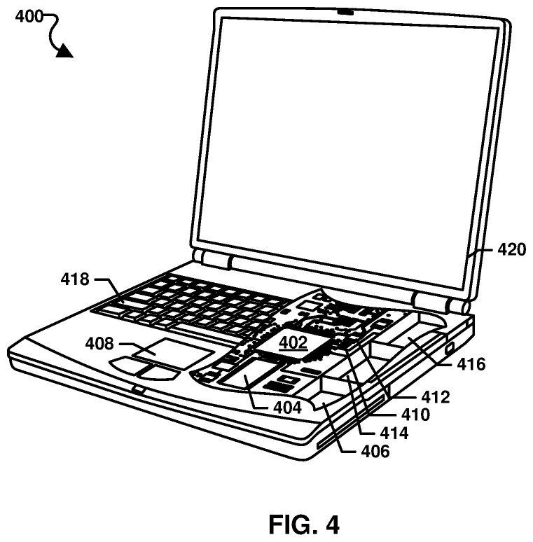

Various embodiments (including, but not limited to, embodiments described above with reference to FIGS. 1-3) may be implemented in a wide variety of wireless devices and computing systems including a laptop computer 400, an example of which is illustrated in FIG. 4. With reference to FIGS. 1-4, a laptop computer may include a processor 402 coupled to volatile memory 404 and a large capacity nonvolatile memory, such as a disk drive 406 of Flash memory. The laptop computer 400 may include a touchpad touch surface 408 that serves as the computer's pointing device, and thus may receive drag, scroll, and flick gestures. Additionally, the laptop computer 400 may have one or more antenna 410 for sending and receiving electromagnetic radiation that may be connected to a wireless data link and/or cellular telephone transceiver 412 coupled to the processor 402. The computer 400 may also include a BT transceiver 414, a compact disc (CD) drive 416, a keyboard 418, and a display 420 all coupled to the processor 402. Other configurations of the computing device may include a computer mouse or trackball coupled to the processor (e.g., via a USB input) as are well known, which may also be used in conjunction with various embodiments.

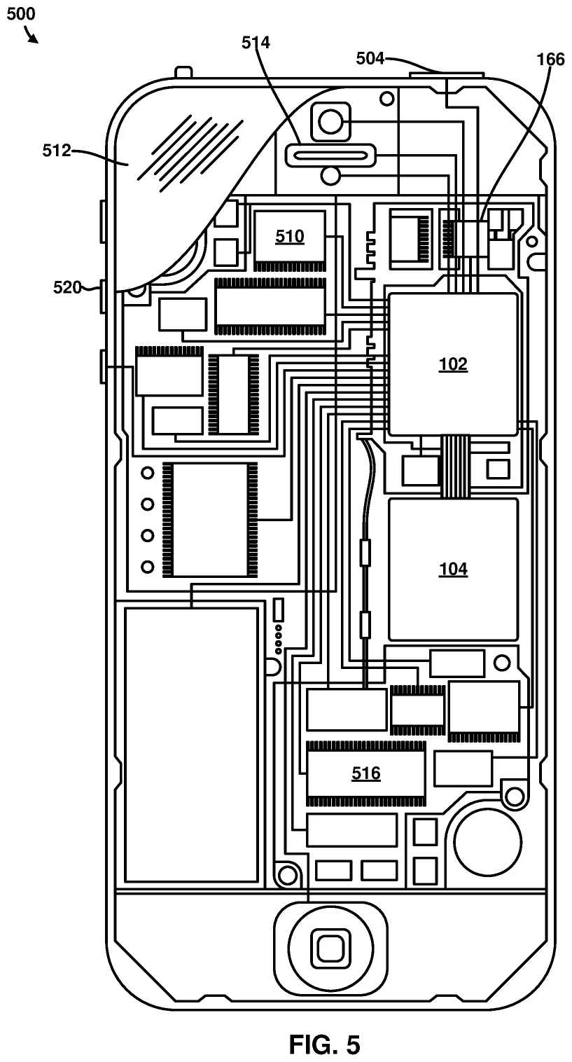

FIG. 5 is a component block diagram of a computing device 500 suitable for use with various embodiments. With reference to FIGS. 1-5, various embodiments may be implemented on a variety of computing devices 500, an example of which is illustrated in FIG. 5 in the form of a smartphone. The computing device 500 may include a first SOC 102 coupled to a second SOC 104. The first and second SoCs 102, 104 may be coupled to internal memory 516, a display 512, and to a speaker 514. The first and second SOCs 102, 104 may also be coupled to at least one subscriber identity module (SIM) 540 and/or a SIM interface that may store information supporting a first 5GNR subscription and a second 5GNR subscription, which support service on a 5G non-standalone (NSA) network.

The computing device 500 may include an antenna 504 for sending and receiving electromagnetic radiation that may be connected to a wireless transceiver 166 coupled to one or more processors in the first and/or second SOCs 102, 104. The computing device 500 may also include menu selection buttons or rocker switches 520 for receiving user inputs.

The computing device 500 also includes a sound encoding/decoding (CODEC) circuit 510, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166 and CODEC 510 may include a digital signal processor (DSP) circuit (not shown separately).

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method of updating firmware on a computing device, the method including receiving an update firmware image from a host device, determining essential image sections and non-essential image sections of a working firmware image stored in a flash memory of the computing device, erasing data in the non-essential image sections from the flash memory, storing essential image sections of the update firmware image to the flash memory, and rebooting the computing device from the essential image sections of the update firmware image stored in the flash memory.

Example 2: The method of example 1, further including storing the data in the non-essential image sections on the host device as a backup image prior to erasing the data in the non-essential image sections from the flash memory.

Example 3: The method of either of examples 1 or 2, further including sending a request to establish a connection to the host device in response to rebooting the computing device from the essential image sections of the update firmware image stored in the flash memory.

Example 4: The method of any of examples 1-3, further including rebooting from the essential image sections of the working firmware image in response to a failure to establish a connection to the host device.

Example 5: The method of any of examples 1-4, further including requesting and receiving the data in the non-essential image sections from the host device after rebooting from the essential image sections of the working firmware image, and storing the received data in flash memory of the computing device.

Example 6: The method of any of examples 1-5, further including in response to successfully reconnecting to the host device committing the essential image sections of the update firmware image to the flash memory, erasing the essential image sections of the working firmware image, and storing non-essential image sections of the update firmware image received from the host device in the flash memory.

Example 7: The method of any of examples 1-6, in which receiving the update firmware image from the host device includes receiving the update firmware image from a remote application operating on a server computing device that is connected to the computing device over wire or wireless communication channels.

Example 8: The method of any of examples 1-6, in which receiving the update firmware image from the host device comprises receiving the update firmware image from a memory controller component of the computing device.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in or by a vehicle's advanced driver assistance system (ADAS), system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
one or more memories;
a flash memory; and
a processing system coupled to the one or more memories and flash memory, and including one or more processors configured to:
receive an update firmware image from a host device;
determine essential image sections and non-essential image sections of a working firmware image stored in the flash memory;
erase data in the non-essential image sections from the flash memory;
store essential image sections of the update firmware image to the flash memory; and
reboot the computing device from the essential image sections of the update firmware image stored in the flash memory.

2. The computing device of claim 1, wherein one or more processors of the processing system are further configured to cause the host device to store the data in the non-essential image sections on a host device memory as a backup image prior to the processing system erasing the data in the non-essential image sections from the flash memory.

3. The computing device of claim 1, wherein one or more processors of the processing system are further configured to send a request to establish a connection to the host device in response to rebooting the computing device from the essential image sections of the update firmware image stored in the flash memory.

4. The computing device of claim 3, wherein one or more processors of the processing system are further configured to reboot from the essential image sections of the working firmware image in response to detecting a failure to establish a connection to the host device.

5. The computing device of claim 4, wherein one or more processors of the processing system are further configured to:
request and receive the data in the non-essential image sections from the host device after rebooting from the essential image sections of the working firmware image; and
store the received data in the flash memory.

6. The computing device of claim 3, wherein one or more processors of the processing system are further configured to:
commit the essential image sections of the update firmware image to the flash memory in response to successfully reconnecting to the host device;
erase the essential image sections of the working firmware image; and
store non-essential image sections of the update firmware image received from the host device in the flash memory.

7. The computing device of claim 1, wherein the host device is a remote application operating on a server computing device that is connected to the computing device over wire or wireless communication channels.

8. The computing device of claim 1, wherein the host device is a memory controller component of the computing device.

9. A method of updating firmware on a computing device, the method comprising:
receiving an update firmware image from a host device;
determining essential image sections and non-essential image sections of a working firmware image stored in a flash memory of the computing device;
erasing data in the non-essential image sections from the flash memory;
storing essential image sections of the update firmware image to the flash memory; and
rebooting the computing device from the essential image sections of the update firmware image stored in the flash memory.

10. The method of claim 9, further comprising storing the data in the non-essential image sections on the host device as a backup image prior to erasing the data in the non-essential image sections from the flash memory.

11. The method of claim 9, further comprising sending a request to establish a connection to the host device in response to rebooting the computing device from the essential image sections of the update firmware image stored in the flash memory.

12. The method of claim 11, further comprising rebooting from the essential image sections of the working firmware image in response to a failure to establish a connection to the host device.

13. The method of claim 12, further comprising:
requesting and receiving the data in the non-essential image sections from the host device after rebooting from the essential image sections of the working firmware image; and
storing the received data in flash memory of the computing device.

14. The method of claim 11, further comprising in response to successfully reconnecting to the host device:
committing the essential image sections of the update firmware image to the flash memory;
erasing the essential image sections of the working firmware image; and
storing non-essential image sections of the update firmware image received from the host device in the flash memory.

15. The method of claim 9, wherein receiving the update firmware image from the host device comprises receiving the update firmware image from a remote application operating on a server computing device that is connected to the computing device over wire or wireless communication channels.

16. The method of claim 9, wherein receiving the update firmware image from the host device comprises receiving the update firmware image from a memory controller component of the computing device.

17. A non-transitory computer readable storage medium having stored thereon processor-executable software instructions configured to cause a processor to perform operations for updating firmware on a computing device, the operations comprising:
receiving an update firmware image from a host device;
determining essential image sections and non-essential image sections of a working firmware image stored in a flash memory of the computing device;
erasing data in the non-essential image sections from the flash memory;
storing essential image sections of the update firmware image to the flash memory; and
rebooting the computing device from the essential image sections of the update firmware image stored in the flash memory.

18. The non-transitory computer readable storage medium of claim 17, wherein the stored processor-executable software instructions are configured to cause a processor to perform operations further comprising storing the data in the non-essential image sections on the host device as a backup image prior to erasing the data in the non-essential image sections from the flash memory.

19. The non-transitory computer readable storage medium of claim 17, wherein the stored processor-executable software instructions are configured to cause a processor to perform operations further comprising sending a request to establish a connection to the host device in response to rebooting the computing device from the essential image sections of the update firmware image stored in the flash memory.

20. The non-transitory computer readable storage medium of claim 19, wherein the stored processor-executable software instructions are configured to cause a processor to perform operations further comprising rebooting from the essential image sections of the working firmware image in response to a failure to establish a connection to the host device.

21. The non-transitory computer readable storage medium of claim 20, wherein the stored processor-executable software instructions are configured to cause a processor to perform operations further comprising:
requesting and receiving the data in the non-essential image sections from the host device after rebooting from the essential image sections of the working firmware image; and
storing the received data in flash memory of the computing device.

22. The non-transitory computer readable storage medium of claim 19, wherein the stored processor-executable software instructions are configured to cause a processor to perform operations further comprising in response to successfully reconnecting to the host device:
committing the essential image sections of the update firmware image to the flash memory;
erasing the essential image sections of the working firmware image; and
storing non-essential image sections of the update firmware image received from the host device in the flash memory.

23. The non-transitory computer readable storage medium of claim 17, wherein the stored processor-executable software instructions are configured to cause a processor to perform operations such that receiving the update firmware image from the host device comprises receiving the update firmware image from a remote application operating on a server computing device that is connected to the computing device over wire or wireless communication channels.

24. The non-transitory computer readable storage medium of claim 17, wherein the stored processor-executable software instructions are configured to cause a processor to perform operations such that receiving the update firmware image from the host device comprises receiving the update firmware image from a memory controller component of the computing device.

25. A computing device, comprising:
means for receiving an update firmware image from a host device;
means for determining essential image sections and non-essential image sections of a working firmware image stored in a flash memory of the computing device;
means for erasing data in the non-essential image sections from the flash memory;
means for storing essential image sections of the update firmware image to the flash memory; and
means for rebooting the computing device from the essential image sections of the update firmware image stored in the flash memory.

26. The computing device of claim 25, further comprising means for storing the data in the non-essential image sections on the host device as a backup image prior to erasing the data in the non-essential image sections from the flash memory.

27. The computing device of claim 25, further comprising means for sending a request to establish a connection to the host device in response to rebooting the computing device from the essential image sections of the update firmware image stored in the flash memory.

28. The computing device of claim 27, further comprising means for rebooting from the essential image sections of the working firmware image in response to a failure to establish a connection to the host device.

29. The computing device of claim 28, further comprising:
means for requesting and receiving the data in the non-essential image sections from the host device after rebooting from the essential image sections of the working firmware image; and
means for storing the received data in flash memory of the computing device.

30. The computing device of claim 27, further comprising:
means for committing the essential image sections of the update firmware image to the flash memory in response to successfully reconnecting to the host device;
means for erasing the essential image sections of the working firmware image; and
means for storing non-essential image sections of the update firmware image received from the host device in the flash memory.
